(19) United States
(12) Patent Application Publication
(10) Pub. No.: US 2004/0196009 A1
(43) Pub. Date: Oct. 7, 2004

(54) Battery charger

(76) Inventor: Sheng-I Yang, Taipei Hsien (TW)

Correspondence Address: RABIN & BERDO, P.C., Suite 500, 1101 14th Street, N.W., Washington, DC, 20005, US

(21) Appl. No.: 10/404,434

(22) Filed: Apr. 2, 2003

(51) Int. Cl. H02J 7/00

(52) U.S. Cl. 320/150

(57) ABSTRACT

The present invention relates to an improved battery charger, more particularly to an improved battery charger applicable for the AA/AAA Ni-MH and Ni-CD rechargeable batteries. By means of the operation of a fan disposed in the battery charger to disperse the heat and lower the temperature of the charging battery, the present invention attains the functions of effectively controlling the battery temperature, enhancing the battery charge capacity, and extending the battery life.

### BACKGROUND OF THE INVENTION

1. Field of the Invention

The present invention relates to an improved battery charger, more particularly to an improved battery charger applicable for the AA/AAA Ni-MH and Ni—CD rechargeable batteries, comprising an upper casing, a retainer, and a lower casing; wherein both the upper and lower casings have a plurality of heat dispersion slots and lamp hole; the retainer for holding a circuit mechanism and an electric conductive bracket, indicating lamp, power switch, and power supply socket, etc, characterized in that a ventilation opening is disposed at the base of the retainer corresponding to the position of the battery compartment, and a fan is disposed on the lower casing corresponsive to such ventilation opening, and the fan is coupled to the circuit mechanism and controlled by the IC of the circuit mechanism such that when the battery charger of the present invention is charging battery, the operation of fan will disperse the heat and lower the temperature of each charging battery, and control the temperature during the battery charging operation below 45˜55° C. The present invention provides a quick battery charge, enhances the battery charge capacity, and extends the battery life.

2. Description of the Related Art

The present common AA/AAA Ni—/CH and Ni—CD rechargeable batteries with high efficiency of fully charging a battery (approximately within an hour) are generally used in many electric appliances, equipments, and products. The prior-art battery charger that works with the rechargeable battery has the same structural mechanism as other models of general battery chargers. When these prior-art batteries are recharged, the temperature of each battery will increase; the temperature of the battery may reach 60° C. or higher when the battery is fully charged. Such high temperature not only shortens the battery life, but also lowers the efficiency of the application since the battery cannot be fully charged under the condition of high temperature, and the charging capacity can only reach 90˜95%.

### SUMMARY OF THE INVENTION

In view of the aforementioned shortcomings of the prior-art battery charger for the AA/AAA Ni-MH and Ni—CD battery, the inventor of the present invention based on years of experience accumulated from the engagement in the battery and power storage related industry conducted extensive research to resolve the aforementioned shortcomings and invented the battery charger of the present invention. After the research and development process including the conception, drafting, trial, test, and modification procedures, the finished goods of the present invention was finally made, and good test results were obtained in the finished goods certification. The successfully developed battery charger has a fan installed at an appropriate position in the battery charger, and the fan is controlled by the IC of the operating circuit mechanism of the battery charger for battery charge, while the heat produced by each battery is dispersed and thus the temperature is lowered. The temperature of the battery can be controlled effectively, and it thus can attain the functions of effectively improving the battery charging capacity and extending the battery life.

The primary objective of the present invention is to provide an improved battery charger that can disperse the heat and lower the temperature of the charging battery to effectively improve the battery charging capacity and extend the battery life.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a perspective diagram showing the disassembled parts of the present invention.

FIG. 2 is a perspective diagram of the assembled battery charger of the present invention.

FIG. 3 shows a battery charging and discharging test report of the first battery of the set of (four pieces) AA/AAA Ni-MH charging batteries tested on a prior-art battery charger.

FIG. 4 shows a battery charging and discharging test report of the second battery of the set of (four pieces) AA/AAA Ni-MH charging batteries tested on a prior-art battery charger.

FIG. 5 shows a battery charging and discharging test report of the third battery of the set of (four pieces) AA/AAA Ni-MH charging batteries tested on a prior-art battery charger.

FIG. 6 shows a battery charging and discharging test report of the fourth battery of the set of (four pieces) AA/AAA Ni-MH charging batteries tested on a prior-art battery charger.

FIG.7 shows a battery charging and discharging test report of the first battery of the set of (four pieces) AA/AAA Ni-MH charging batteries tested on a battery charger according to the present invention.

FIG. 8 shows a battery charging and discharging test report of the second battery of the set of (four pieces) AA/AAA Ni-MH charging batteries tested on a battery charger according to the present invention.

FIG. 9 shows a battery charging and discharging test report of the third battery of the set of (four pieces) AA/AAA Ni-MH charging batteries tested on a battery charger according to the present invention.

FIG. 10 shows a battery charging and discharging test report of the fourth battery of the set of (four pieces) AA/AAA Ni-MH charging batteries tested on a battery charger according to the present invention.

### DETAILED DESCRIPTION OF THE PREFERRED EMBODIMENTS

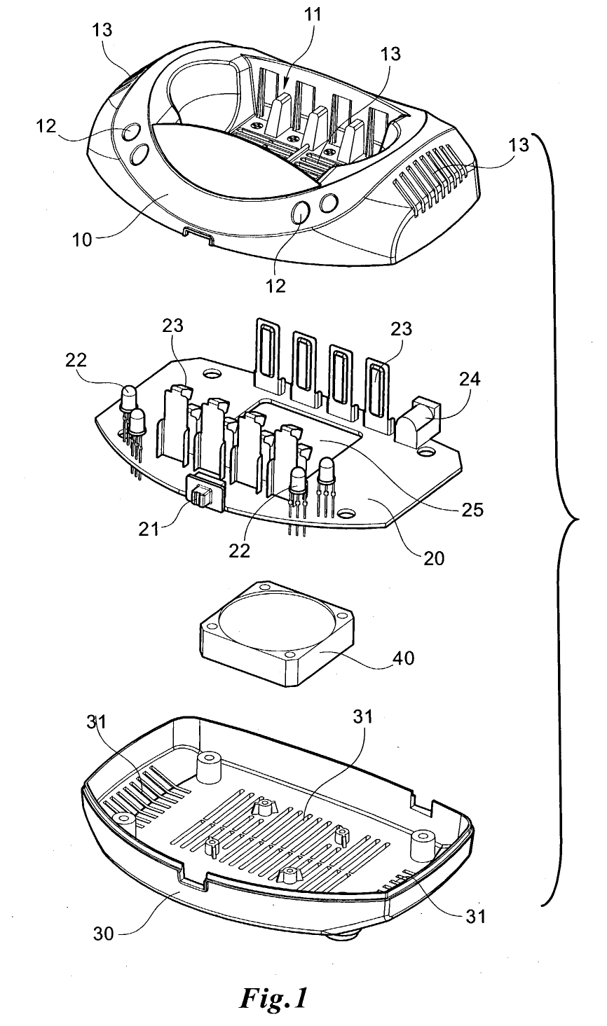

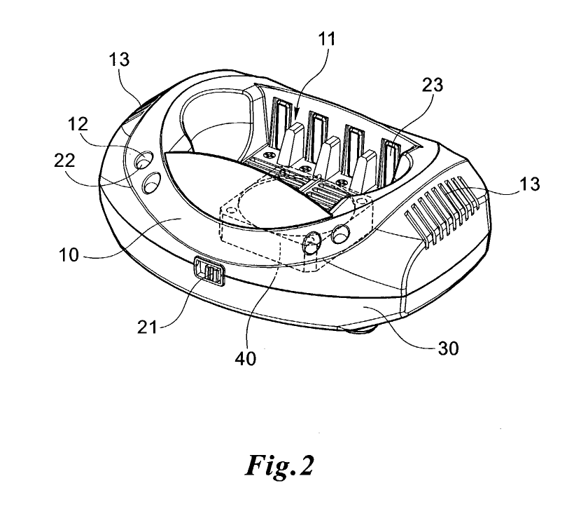

Please refer to the FIGS. 1 and 2 for the battery charger of the present invention, which comprises an upper casing 10, a retainer 20, and a lower casing 30; wherein the upper casing 10 further comprising a battery compartment 11 for accommodating the battery, a plurality of lamp holes 12 disposed at the front end, and a plurality of heat dispersion slots 13 at the appropriate positions of the upper casing 10; a retainer 20 for holding the charging circuit mechanism, a power switch 21 disposed at the front end of the retainer, a plurality of indicating lamps 22 on both sides of the retainer, a plurality of symmetric conductive brackets 23 disposed on both of the front and rear edges, and a power socket 24 is disposed at the rear edge of the retainer; characterized in that the retainer 20 comprises a ventilation opening 25 at the position corresponsive to the battery compartment 11 of the upper casing 10 and a fan 40 is disposed in the lower casing 30 at a position corresponsive to the ventilation opening 25, and the fan 40 is coupled to the charging circuit mechanism and controlled by the IC in the circuit mechanism.

According to the structure of the present invention, each component including the lower casing 10, retainer 20, fan 40, and lower casing 30 is assembled in sequence to constitute a battery charger, such that the fan 40 is located exactly beneath the battery compartment 11. When the AA/AAA Ni-MH or Ni—CD battery is charged, the fan of the present invention will start operating according to the charging operation, and will be controlled by the program setting of the IC (intermittent operation or rotation speed) to disperse heat for the charging batter, so that the temperature of the battery can be effectively controlled within the safe range (about 45˜55° C.).

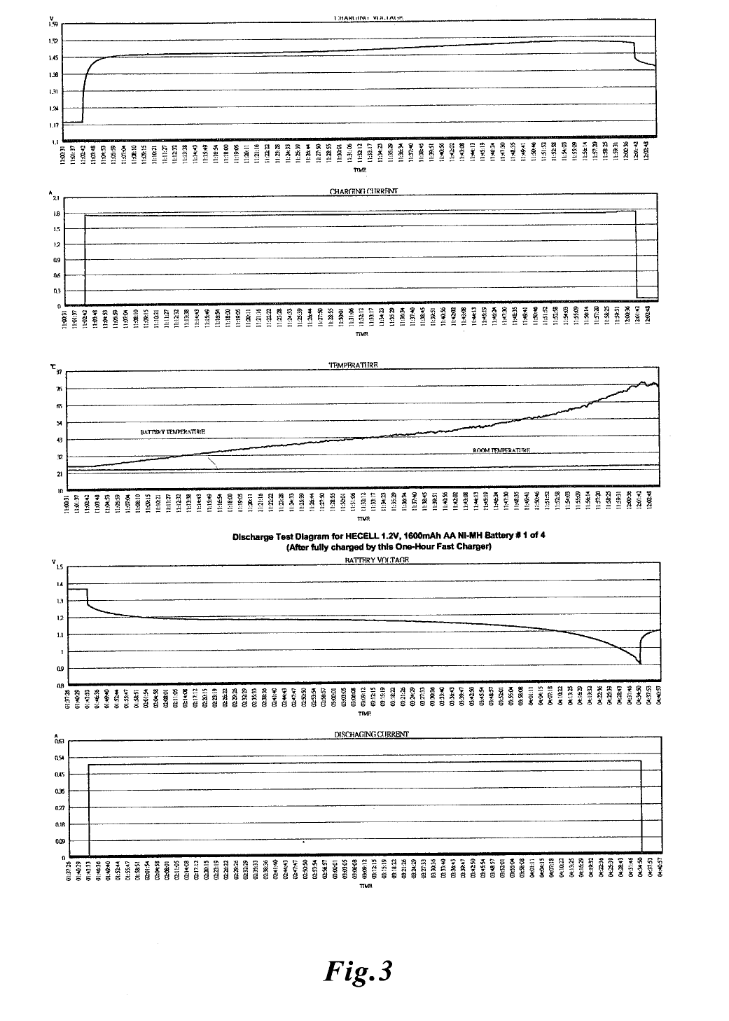

Please refer to the FIGS. 3 to 10 for the test reports of charging and discharging a set (4 pieces) of the AA/AAA Ni-MH rechargeable batteries being charged separately by the prior-art battery charger and the battery charger of the present invention. The testing equipment includes the FLUKE HYDRA SERIES II voltage recorder; the testing condition is at 25° C. room temperature; the output current is 15.0V DC 20 W for the battery charging. The discharging test is based on the discharge of the battery to the voltage of 0.9V. The same standards were applied to the prior-art and the present invention, of which:

(1) FIG. 3 shows the test result of the first battery of a set of prior-art batteries being charged on a prior-art battery charger and indicates that the charge time is 59 minutes. The discharge test on a fully charged battery shows that the discharge current of such battery is 500 mA, and the discharge time is 172 minutes, and the capacitance of such battery is 1433 mAh.

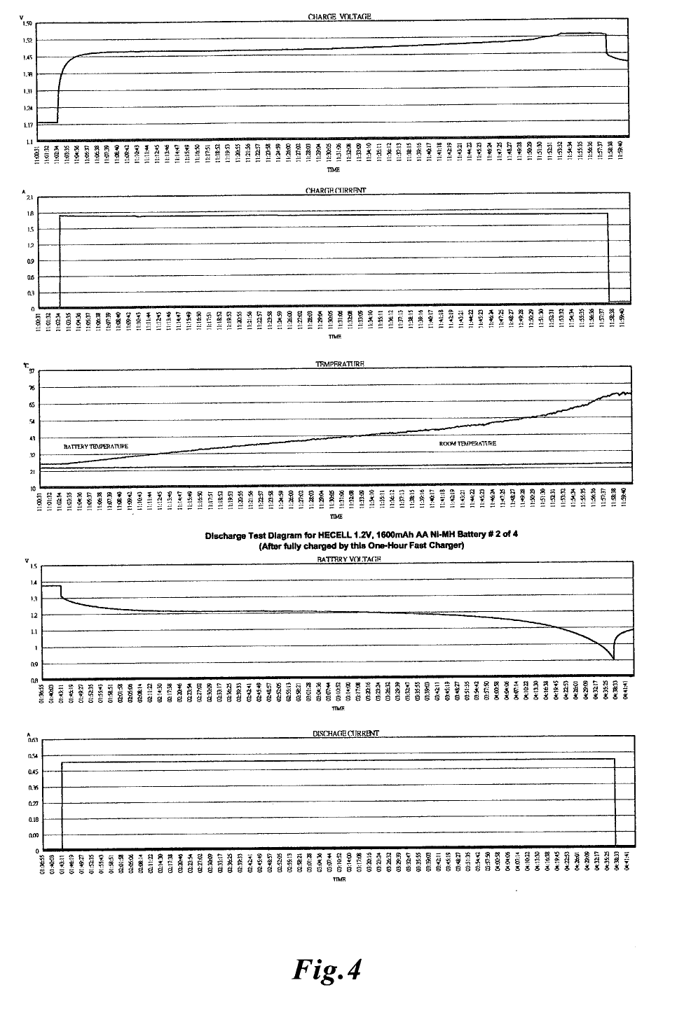

(2) FIG. 4 shows the test result of the second battery of a set of prior-art batteries being charged on a prior-art battery charger and indicates that the charge time is 56 minutes. The discharge test on a fully charged battery shows that the discharge current of such battery is 500 mA, and the discharge time is 174 minutes, and the capacitance of such battery is 1450 mAh.

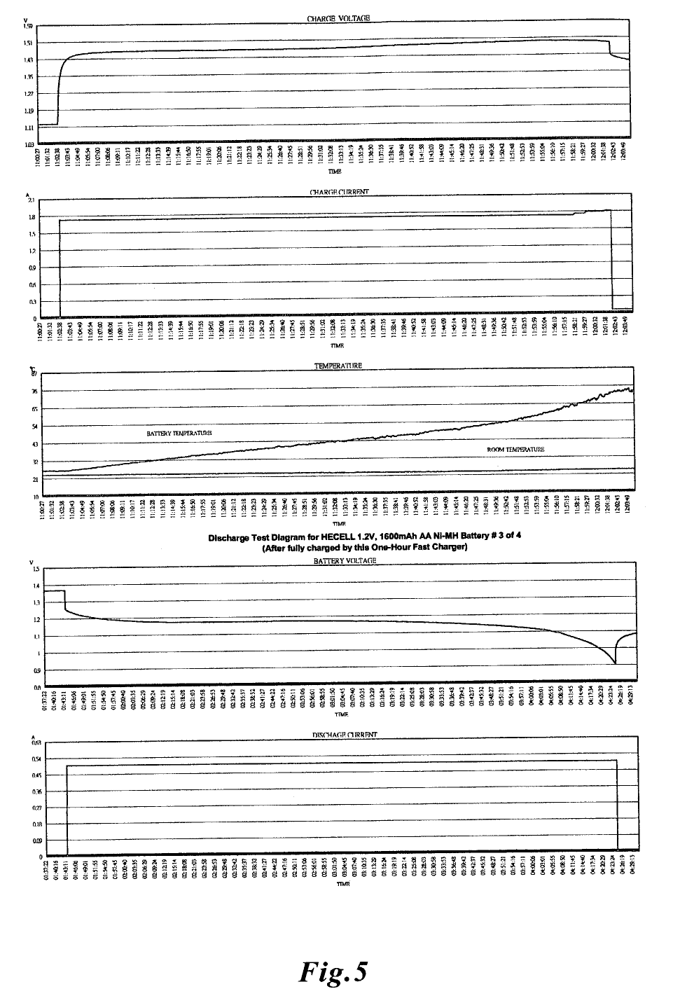

(3) FIG. 5 shows the test result of the third battery of a set of prior-art batteries being charged on a prior-art battery charger and indicates that the charge time is 60 minutes. The discharge test on a fully charged battery shows that the discharge current of such battery is 500 mA, and the discharge time is 169 minutes, and the capacitance of such battery is 1408 mAh.

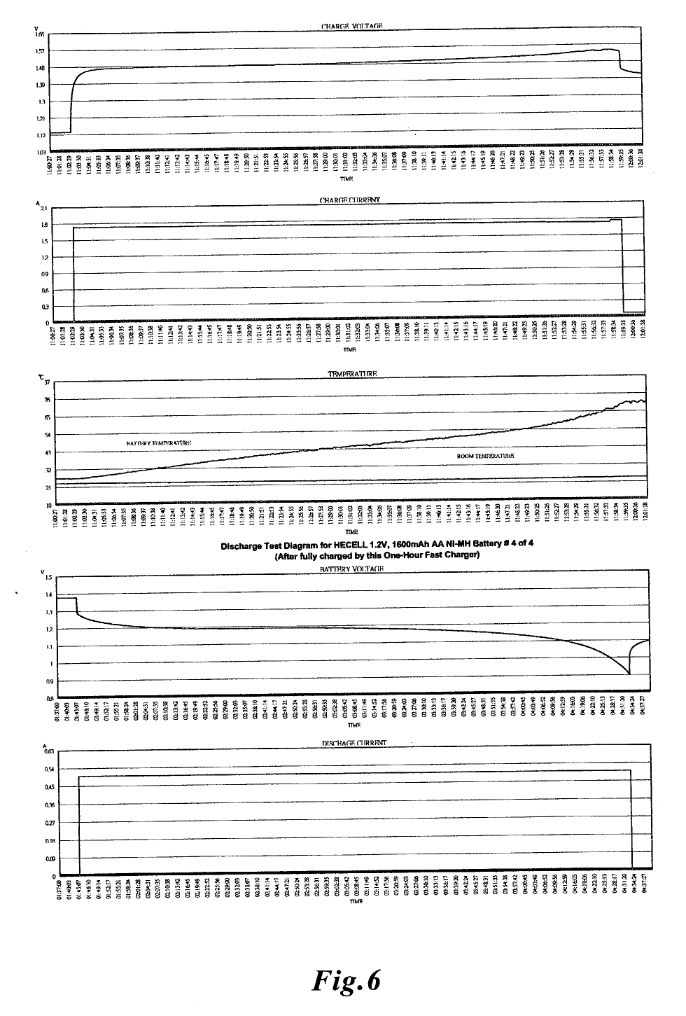

(4) FIG. 6 shows the test result of the fourth battery of a set of prior-art batteries being charged on a prior-art battery charger and indicates that the charge time is 57 minutes. The discharge test on a fully charged battery shows that the discharge current of such battery is 500 mA, and the discharge time is 170 minutes, and the capacitance of such battery is 1416 mAh.

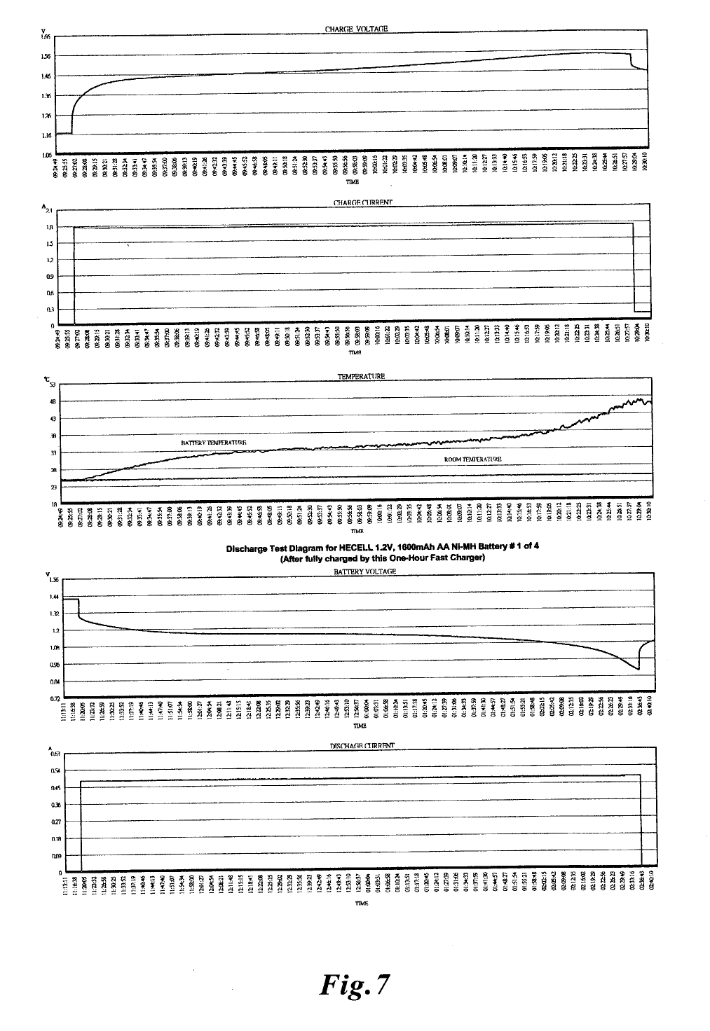

(5) FIG. 7 shows the test result of the first battery of a set of batteries of the present invention being charged on a prior-art battery charger and indicates that the charge time is 62 minutes. The discharge test on a fully charged battery shows that the discharge current of such battery is 485 mA, and the discharge time is 198 minutes, and the capacitance of such battery is 1600 mAh.

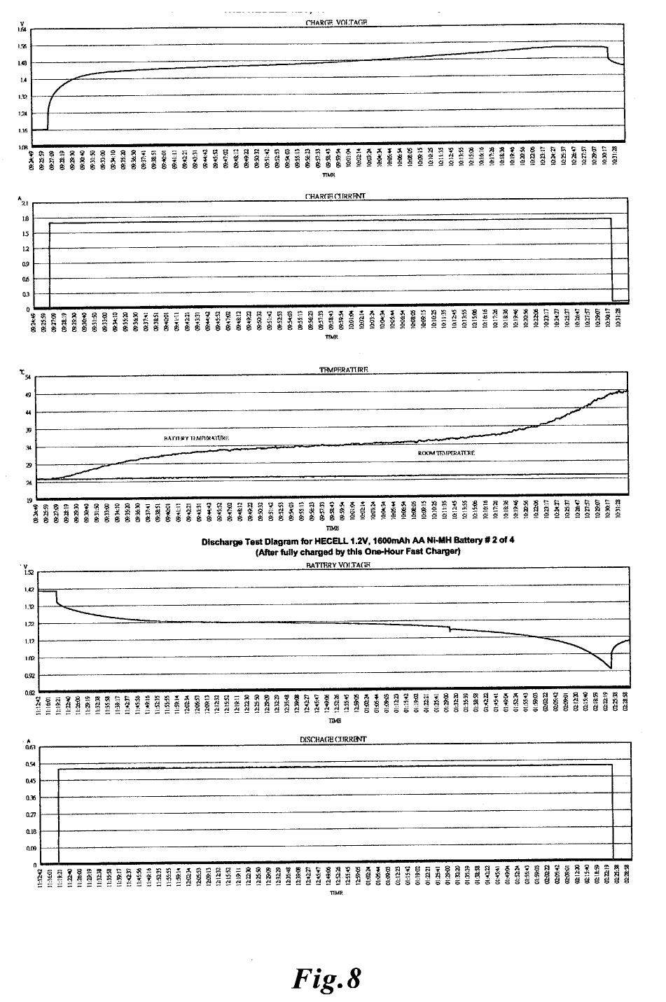

(6) FIG. 8 shows the test result of the second battery of a set of batteries of the present invention being charged on a prior-art battery charger and indicates that the charge time is 64 minutes. The discharge test on a fully charged battery shows that the discharge current of such battery is 514 mA, and the discharge time is 186 minutes, and the capacitance of such battery is 1593 mAh.

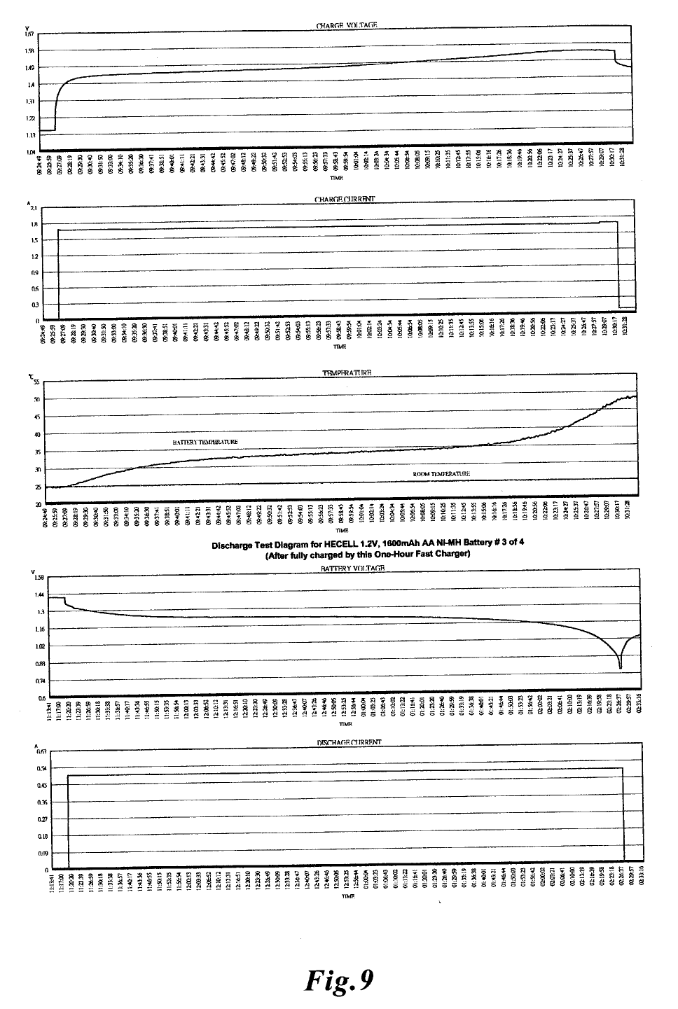

(7) FIG. 9 shows the test result of the third battery of a set of batteries of the present invention being charged on a prior-art battery charger and indicates that the charge time is 64 minutes. The discharge test on a fully charged battery shows that the discharge current of such battery is 506 mA, and the discharge time is 189 minutes, and the capacitance of such battery is 1594 mAh.

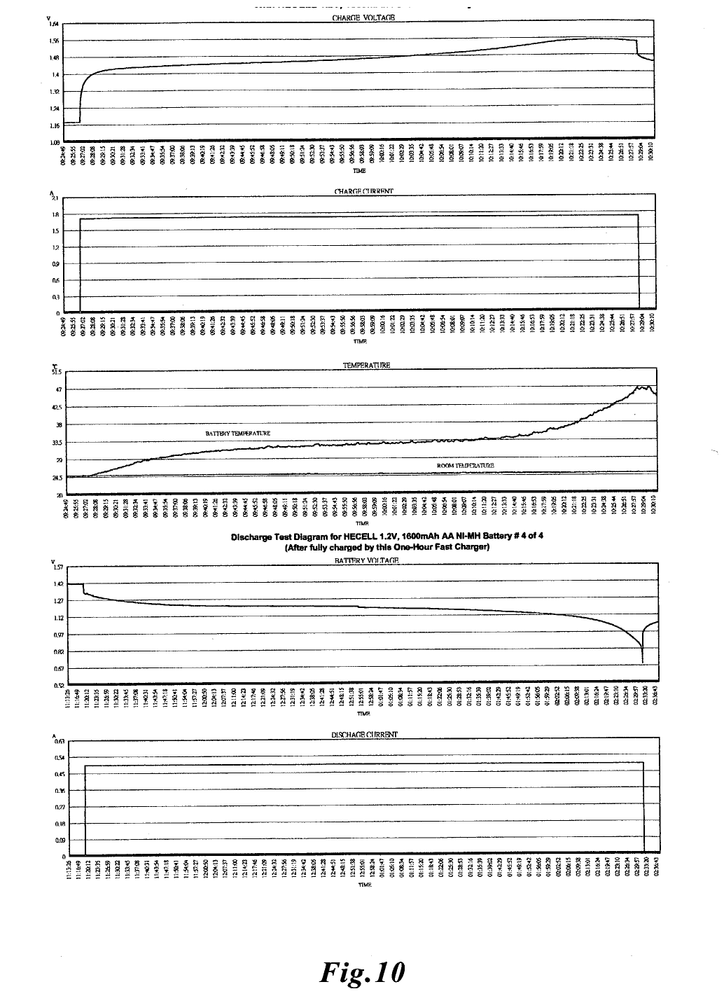

(8) FIG. 10 shows the test result of the fourth battery of a set of batteries of the present invention being charged on a prior-art battery charger and indicates that the charge time is 62 minutes. The discharge test on a fully charged battery shows that the discharge current of such battery is 494 mA, and the discharge time is 194 minutes, and the capacitance of such battery is 1597 mAh.

The comparison of the test results of the same set (four pieces) of batteries being charged and discharged by the prior-art charger and the charger of the present invention obviously shows that the battery charging capacity and power efficiency under the same conditions can be enhanced effectively (the efficiency is up to 98˜100%), and the temperature of the batteries is lower than the temperature produced during the battery charge of the prior-art charger. The present invention can effective lower the damage to the battery and extend the battery life.

In summation of the above description, the present invention is a carefully designed structure that provides a fan for ventilating the charger to lower the battery temperature during the battery charging operation. Therefore, the temperature of the battery can be controlled within the safe range. The present invention attains the functions of improving the charging capacity and extending the battery life. Compared with the prior art of similar product, the present invention definitely have enhanced the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved battery charger, comprising an upper casing, a retainer, and a lower casing, wherein the upper casing further comprising a battery compartment, a lamp hole, and a plurality of heat dispersion slots; the retainer holding a battery charging circuit mechanism and having a power switch, an indicating lamp, a plurality of conductive brackets, and a power supply socket; the lower casing having a plurality of heat dispersion slots; characterized in that the retainer comprises a ventilation opening disposed at a position corresponsive to the position of the battery compartment of the upper casing, and a fan disposed on the lower casing at the position corresponsive to the position of the ventilation opening, and said fan being coupled to the charging circuit and controlled by an IC of the circuit.
